(19) United States
(12) Patent Application Publication
(10) Pub. No.: US 2022/0190682 A1
(43) Pub. Date: Jun. 16, 2022

(54) MOTOR-COOLING APPARATUS

(71) Applicants: HYUNDAI MOTOR COMPANY, Seoul (KR); KIA CORPORATION, Seoul (KR)

(72) Inventors: Jae Hyeok Song, Incheon (KR); Young Chul Kim, Gwangmyeong-si (KR); Young Jin Shin, Changwon-si (KR)

(21) Appl. No.: 17/462,652

(22) Filed: Aug. 31, 2021

(30) Foreign Application Priority Data
Dec. 10, 2020 (KR) 10-2020-0172636

(51) Int. Cl. H02K 9/19; H02K 1/20; H02K 5/20; H02K 3/24

(52) U.S. Cl. CPC H02K 9/19; H02K 3/24; H02K 5/203; H02K 1/20

(57) ABSTRACT

A motor-cooling apparatus is constructed such that coils constituting a stator are cooled using cooling fluid supplied from a first channel pipe and a second channel pipe, and the ends of the coils, which are difficult to sufficiently cool when cooling of the motor, are efficiently cooled, thereby ensuring the durability of the motor.

### CROSS REFERENCE TO RELATED APPLICATIONS

This application claims the priority benefit of Korean Patent Application No. 10-2020-0172636, filed on Dec. 10, 2020, in the Korean Intellectual Property Office, the disclosure of which is incorporated herein by reference.

### BACKGROUND

### 1. Field

The present disclosure relates to a motor-cooling apparatus configured to improve the cooling efficiency of a motor.

### 2. Description of the Related Art

A motor is a power-generating element that is universally used in the modern industry. When a rotor is operated upon activation of the motor, high-temperature heat easily accumulates in a motor housing, regardless of whether the motor is a large-sized motor for supplying high power or a small-sized motor for supplying low power. Furthermore, because a conventional motor does not have a structure capable of rapidly dissipating high-temperature heat, the magnetic force of a magnet is reduced due to the high-temperature heat accumulated in the motor, and the operation efficiency of the motor is increasingly deteriorated. In addition, when the temperature of the motor increases to a certain level, the internal components may break, thereby causing a fire in the motor.

Accordingly, because a larger amount of heat is generated in the coil and the like during operation of the motor, the components must be cooled. Motors are classified according to the cooling method into an air-cooling type, a water-cooling type and an oil-cooling type or a direct cooling type and an indirect cooling type. In recent years, because the cooling efficiency of a motor must be improved along with improvements in the performance of a motor, the trend is to apply a direct cooling type using oil.

However, in the case of a direct-cooling-type motor using oil, a specific portion of a motor may be overly heated and damaged due to non-uniform distribution of cooling oil. In other words, because ends of coils in a stator of the motor are difficult for the cooling oil to access and are thus difficult to sufficiently cool, technology for preventing damage to a motor is required.

The details described as the background art are intended merely for the purpose of promoting an understanding of the background of the present disclosure, and should not be construed as an acknowledgment of the prior art that is previously known to those of ordinary skill in the art.

### SUMMARY

Therefore, the present disclosure has been made in view of the above problems, and it is an object of the present disclosure to provide a motor-cooling apparatus configured to efficiently cool a stator, which is a portion difficult to sufficiently cool when cooling a motor, thereby ensuring the durability of the motor.

In accordance with the present disclosure, the above and other objects can be accomplished by the provision of a motor-cooling apparatus including a motor housing including therein a rotor and a stator around which coils are wound, a first channel pipe disposed outside the stator so as to spray cooling fluid to an outside of the coils, and a second channel pipe disposed inside the stator so as to spray the cooling fluid to an inside of the coils.

First ends and second ends of the coils in the stator may be exposed from two ends of the motor housing.

The first channel pipe may include a plurality of first channel pipes, which are disposed along an outer periphery of the stator and extend in the longitudinal direction of the motor housing so as to spray the cooling fluid to one or both of the first ends and the second ends of the coils.

The stator may be provided on the outer circumferential surface thereof with a bracket, and the first channel pipe may be disposed on the outer circumferential surface of the stator beside the bracket.

The first channel pipe may be disposed at an upper side of the stator such that the cooling fluid sprayed from the first channel pipe flows downwards along the coils while cooling the coils.

The first channel pipe may include a pair of first channel pipes, which are disposed at an upper side of the stator and are spaced apart from each other in the circumferential direction of the stator.

The second channel pipe may be disposed inside the coils so as to correspond to one or both of the first ends and the second ends of the coils, and may extend in the circumferential direction of the stator so as to spray the cooling fluid to the inside of the coils.

The second channel pipe may be configured to spray the cooling fluid to the inside of the coils in two lateral directions.

The first channel pipe and the second channel pipe may be configured such that the path of the cooling fluid sprayed from the first channel pipe and the path of the cooling fluid sprayed from the second channel pipe do not overlap each other outside and inside the coils.

The first channel pipe may spray the cooling fluid under spraying pressure sufficient to move the cooling fluid to the inside of the coils from the outside of the coils.

The motor housing may include therein an oil channel, in which the cooling fluid is circulated, and the first channel pipe and the second channel pipe may be connected to the oil channel so as to share the cooling fluid.

The stator may include a plurality of slots, which are formed in the inner circumferential surface of the stator and are arranged in a circumferential direction, and the coils may be hairpin-type coils fitted into respective ones among the plurality of slots.

### BRIEF DESCRIPTION OF THE FIGURES

The above and other objects, features and other advantages of the present disclosure will be more clearly understood from the following detailed description taken in conjunction with the accompanying drawings, in which:

FIGS. 1 and 2 are views illustrating a motor-cooling apparatus according to an embodiment of the present disclosure;

FIG. 3 is a cross-sectional view illustrating the motor-cooling apparatus shown in FIG. 1;

FIG. 4 is a side view illustrating the motor-cooling apparatus shown in FIG. 1;

FIG. 5 is a front view illustrating the motor-cooling apparatus shown in FIG. 1; and

FIG. 6 is a view illustrating the motor-cooling apparatus shown in FIG. 1.

### DETAILED DESCRIPTION

Reference will now be made in detail to the preferred embodiments of the present disclosure, examples of which are illustrated in the accompanying drawings. Wherever possible, the same reference numbers will be used throughout the drawings to refer to the same or like parts.

Hereinafter, a motor-cooling apparatus according to a preferred embodiment of the present disclosure will be described in detail with reference to the accompanying drawings.

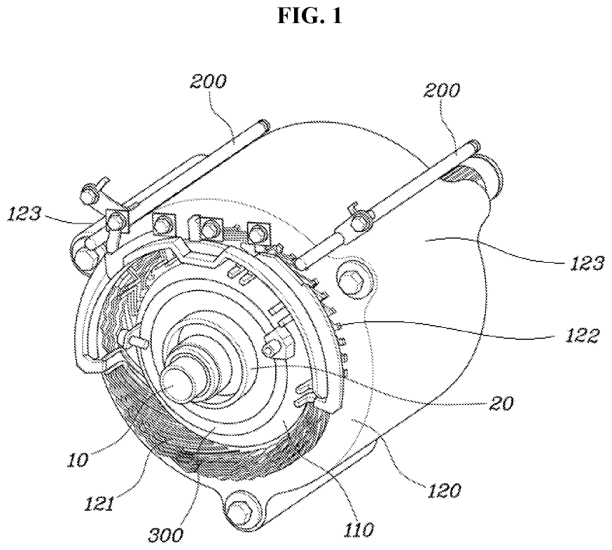

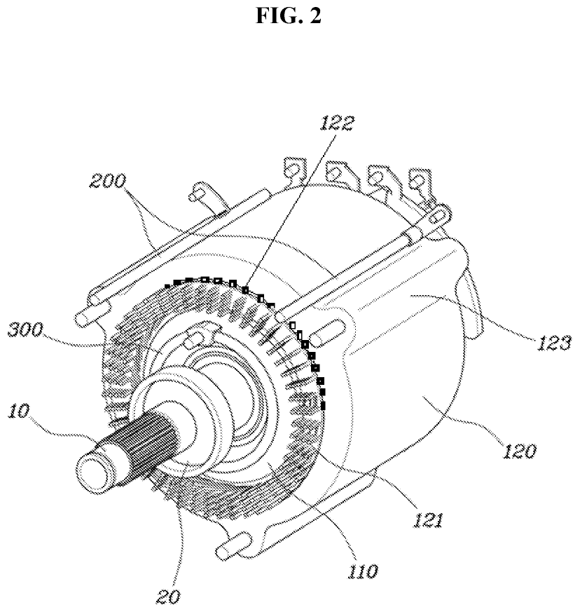

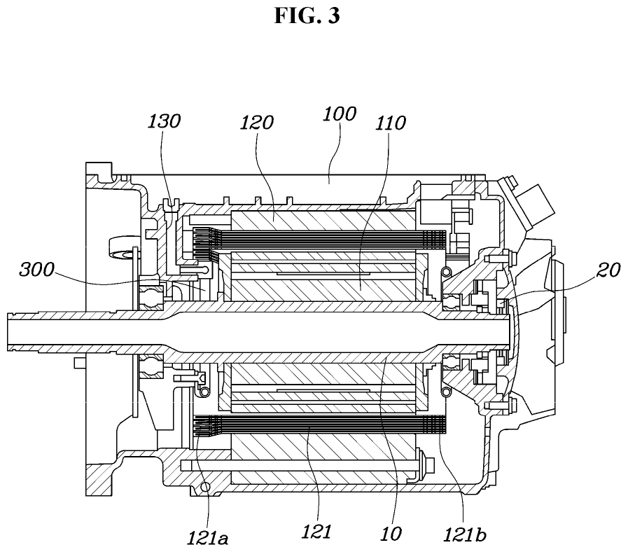

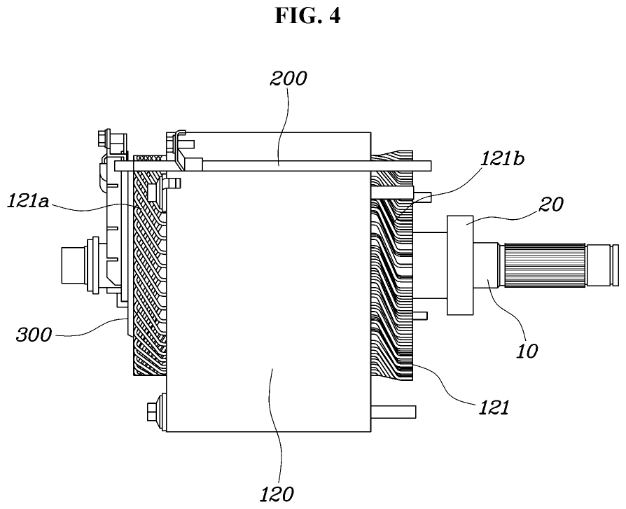

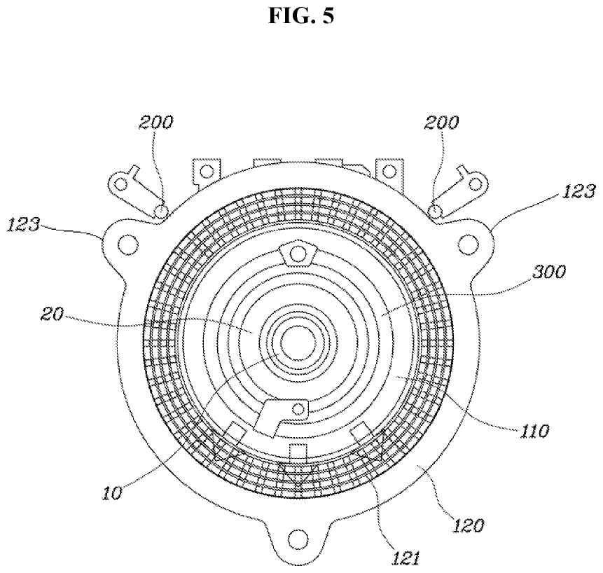

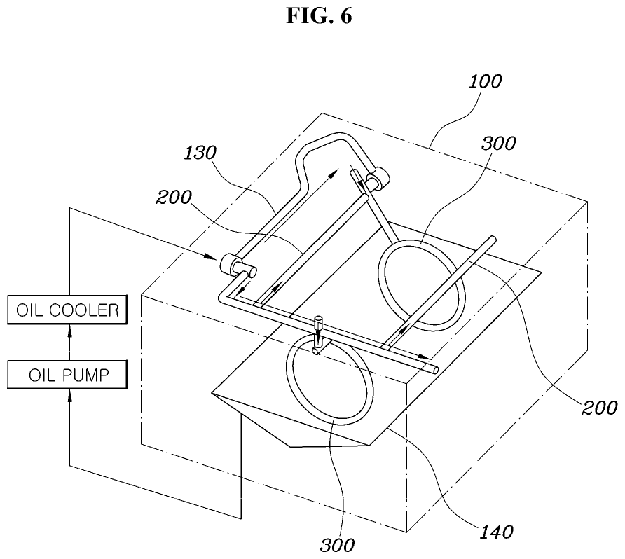

FIGS. 1 and 2 are views illustrating a motor-cooling apparatus according to an embodiment of the present disclosure. FIG. 3 is a cross-sectional view illustrating the motor-cooling apparatus shown in FIG. 1. FIG. 4 is a side view illustrating the motor-cooling apparatus shown in FIG. 1. FIG. 5 is a front view illustrating the motor-cooling apparatus shown in FIG. 1. FIG. 6 is a view illustrating the motor-cooling apparatus shown in FIG. 1.

As illustrated in FIGS. 1 and 2, the motor-cooling apparatus according to the present disclosure includes a motor housing 100 including a rotor 110 and a stator 120 around which coils 121 are wound, a first channel pipe 200 provided outside the stator 120 so as to spray cooling fluid to the outside of the coils 121, and a second channel pipe 300 provided inside the stator 120 so as to spray cooling fluid to the inside of the coils 121.

The motor to which the present disclosure is applied includes motor components such as a motor shaft 10 and a bearing 20 in addition to the rotator 110 and the stator 120 inside the motor housing 100. The present disclosure is intended to improve the cooling performance for a high-performance motor by cooling the coils 121 using oil.

The stator 120 may have a plurality of slots 122 formed in the inner surface thereof so as to be arranged in a circumferential direction, and hairpin-type rectangular coils 121 may be fitted into the slots 122 in the stator 122. In other words, since the hairpin-type rectangular coils 121 are fitted into the slots 122 in the stator 120 so as to thereby be wound around the stator 120, the coils 121 radially and inwardly fitted into the slots 122 in the stator 120 define a plurality of layers. Hence, because there are gaps between the slots 122 and the layers of the coil 121, the cooling fluid sprayed from the first channel pipe 200 and the second channel pipe 300 may flow through the gaps.

The present disclosure is intended to improve the cooling performance for a motor. Specifically, the present disclosure is intended to improve the cooling performance for the coils 121, particularly for the ends of the coils 121, which are portions which are likely to be insufficiently cooled. Hence, first ends 121a and second ends 121b of the coils 121 in the stator 120 may be exposed from the two ends of the motor housing 100. Here, since the coils 121 are disposed so as to form the gaps between the individual layers of the coils, the cooling oil flows through the gaps while cooling the coils 121, thereby improving the cooling performance.

The first channel pipe 200 for spraying the cooling fluid to the outside of the coils 121 is provided outside the stator 120. The first channel pipe 200 may be fixed to the motor housing 100 via a bracket, and may be provided with a nozzle or a hole so as to spray the cooling fluid toward the coils 121 in the stator 120. Here, the cooling fluid may be oil, and the oil sprayed from the first channel pipe 200 may flow to the inside from the outside of the coils 121 while cooling the coil 121.

The second channel pipe 300 for spraying the cooling fluid to the inside of the coils 121 may be provided inside the stator 120. The second channel pipe 300 may be fixed to the motor housing 100 via a bracket, and may be provided with a nozzle or a hole so as to spray the cooling fluid toward the inside of the coils 121 in the stator 120. In this way, the second channel pipe 300 sprays the cooling fluid to the inside of the coils 121 in the stator 120, and the cooling fluid flows to the outside from the inside of the coils 121 while cooling the coil 121. Particularly, the cooling fluid sprayed from the second channel pipe 300 is spattered by the centrifugal force resulting from the rotation of the rotor 110, and the force acting toward the inside of the coil 121 from the outside thereof is generated, thereby improving the cooling efficiency of the coils 121.

As described above, according to the present disclosure, since the first channel pipe 200 and the second channel pipe 300, which are provided at the motor housing 100, spray the cooling fluid to the outside and the inside of the coils 121, the cooling efficiency of the coils 121 is improved. Furthermore, since the cooling fluid sprayed from the second channel pipe 300 flows to the outside from the inside of the coils 121 due to the rotation of the rotor 110, the cooling fluid is circulated through the coils 121, thereby improving the cooling performance.

Specifically, according to the present disclosure, the first channel pipe 200 includes a plurality of first channel pipes, which are disposed along the periphery of the stator 120 and extend in the longitudinal direction of the motor housing 100 so as to spray the cooling fluid to both or one of the first ends 121a and the second ends 121b.

In other words, the plurality of first channel pipes 200 are disposed along the periphery of the stator 120 so as to spray oil to the coils 121 at different positions. Here, in order for the first channel pipes 200 to spray oil to the first ends 121a and the second ends 121b of the coils 121, the first channel pipes 200 extend in the longitudinal direction of the motor housing 100. Depending on the required cooling value of the coil 121, the first channel pipes 200 may be configured to spray the cooling fluid to one or both of the first ends 121a and the second ends 121b of the coils 121.

Specifically, the first channel pipes 200 may be disposed beside brackets 123 projecting from the outer circumferential surface of the stator 120. In other words, since the brackets 123 are formed on the outer circumferential surface of the stator 120, the stator 120 may be fastened to the motor housing 100 via the brackets 123 through bolting or riveting. Because the stator 120 is configured to have a cylindrical shape and the brackets 123 project from the outer circumferential surface of the stator 120, spaces are defined between the brackets 123 in the circumferential direction. Because the first channel pipes 200 are disposed in the spaces defined between the brackets 123 projecting from the stator 120, the overall size of the motor housing 100 is decreased.

Furthermore, because the first channel pipes 200 are disposed at an upper side of the stator 120, the sprayed cooling fluid flows downwards along the coils 121 while cooling the coils 121. When the number of first channel pipes 200 disposed along the periphery of the stator 120 increases, the cooling efficiency of the coils 121 is improved. However, when the number of the first channel pipes 200 is excessively high, the overall size of the motor housing 100 increases, the structure is complicated, and waste of the cooling fluid increases due to unnecessary circulation of the cooling fluid. Accordingly, because the first channel pipes 200 are disposed at an upper side of the stator 120, the cooling fluid sprayed from the first channel pipes 200 flows downwards along the coils 121 while cooling the remaining coils 121.

Specifically, the first channel pipes 200 may include a pair of first channel pipes, and may be spaced apart from each other in the circumferential direction of the stator 120 at the upper side of the stator 120. In one embodiment, the first channel pipes 200 are positioned at the 10 o'clock point and the 2 o'clock point with respect to the center of the stator 120 so as to be spaced apart from each other, whereby the cooling fluid sprayed from the first channel pipes 200 is supplied to the two lateral sides of the coils 121. Hence, since the oil sprayed from the first channel pipes 200 flows downwards, all of the coils 121 in the stator 120 are cooled.

The second channel pipe 300 is disposed inside the stator 120 so as to correspond to one or both of the first ends 121a and the second ends 121b of the coils 121 and extends along the inner periphery of the stator 120 such that the cooling fluid is sprayed to the inside of the coils 121. Because the second channel pipe 300 must be disposed inside the stator 120 and must spray the cooling fluid to the inside of the coils 121, the second channel pipe 300 may be configured to have a ring shape extending in the circumferential direction of the stator 120. Furthermore, the second channel pipe 300 may include two second channel pipes, which are respectively disposed at the first ends 121a and the second ends 121b of the coils 121 so as to cool the first ends 121a and the second ends 121b of the coils 121.

In this way, the second channel pipes 300 are respectively provided at the two ends of the stator 120 so as to spray the cooling fluid to the first ends 121a and the second ends 121b of the coils 121. The cooling fluid supplied to the coils 121 is spattered by the centrifugal force of the rotor 110, and is moved from the inside to the outside of the coils 121. Consequently, the coils 121 are efficiently cooled using the cooling fluid, which is moved from the inside to the outside while being spattered due to the rotation of the rotor 110.

The second channel pipes 300 may be configured so as to spray in two opposite directions toward the inside of the coils 121. In one embodiment, the second channel pipes 300 are configured to spray the cooling fluid at the 3 o'clock point and the 9 o'clock point with respect to the center of the stator 120 such that the cooling fluid sprayed from the second channel pipes 300 is supplied to the two lateral sides of the layers of the coils 121. Consequently, since the cooling fluid sprayed from the second channel pipes 300 flows downwards, all of the coils 121 in the stator 120 are is cooled.

As described above, the first channel pipes 200 spray the cooling fluid to the outside of the coils 121 from the outside of the stator 120 at the 10 o'clock point and the 2 o'clock point, and the second channel pipes 300 spray the cooling fluid to the inside of the coils 121 from the inside of the stator 120 at the 3 o'clock point and the 9 o'clock point. Consequently, since the cooling fluid sprayed from the first channel pipes 200 and the second channel pipes 300 flows downwards along the layers of the coils 121, the coils 121 in the stator 120 are efficiently cooled throughout the entire area thereof. Furthermore, since the cooling fluid that is sprayed to the inside of the coils 121 from the second channel pipes 300 flows to the outside from the inside of the coils 121 due to the centrifugal force resulting from rotation of the rotor 110, the coils 121 are further efficiently cooled.

The first channel pipes 200 and the second channel pipes 300 may be configured such that the path of the cooling fluid sprayed from the first channel pipes 200 and the path of the cooling fluid sprayed from the second channel pipes 300 do not overlap each other in the inside and the outside of the coils 121. According to the present disclosure, the first channel pipe 200 must be configured such that the cooling fluid sprayed therefrom is moved to the inside from the outside of the coils 121, and the second channel pipe 300 must be configured such that the cooling fluid sprayed therefrom is moved to the outside from the inside of the coils 121. Hence, the first channel pipes 200 and the second channel pipes 300 are configured such that the paths of the cooling fluid sprayed therefrom do not overlap each other in the inside and outside of the coils 121, whereby the cooling fluid sprayed from the first and second channel pipes is efficiently moved to the outside and the inside of the coils 121.

The first channel pipes 200 may be configured so as to spray the cooling fluid under such a spraying pressure as to be capable of moving the cooling fluid to the inside from the outside of the coils 121. The spraying pressure of the first channel pipes 200 may be determined according to the size of the nozzle or hole in each of the first channel pipes 200. Since the first channel pipes 200 spray the cooling fluid with a spraying pressure sufficient to be capable of moving the cooling fluid to the inside from the outside of the coils 121, the cooling fluid is efficiently moved to the inside from the outside of the coil 121, thereby improving the cooling performance.

An oil channel 130, in which the cooling fluid is circulated, may be formed in the motor housing 100 such that the first channel pipes 200 and the second channel pipes 300 share the cooling fluid. In other words, the motor housing 100 is provided therein with the oil channel 130 for cooling the entire motor housing 100 and for the supply of oil to motor components such as the motor shaft and the bearings. Here, since the first channel pipes 200 and the second channel pipes 300 are connected to the oil channel 130 so as to share the cooling fluid, the channel package for circulating the cooling fluid is simplified.

As illustrated in FIG. 6, the motor housing 100 is provided therein with the oil channel 130 for supplying the cooling fluid to the motor components, and the first channel pipes 200 and the second channel pipes 300 are connected to the oil channel 130, thereby sharing the cooling fluid.

An oil reservoir 140 for containing the cooling fluid therein may be provided under the stator 120 in the motor housing 100, and the cooling fluid accumulated in the oil reservoir 140 may be supplied to the oil channel 130 through an oil cooler by actuation of an oil pump, thereby establishing an oil circulation structure.

In the motor-cooling apparatus constructed as described above, the coils 121 constituting the stator 120 are cooled using the cooling fluid supplied from the first channel pipe 200 and the second channel pipe 300. Particularly, the ends of the coils 121, which are difficult to sufficiently cool when cooling the motor, are efficiently cooled, thereby ensuring the durability of the motor.

As is apparent from the above description, the present disclosure provides a motor-cooling apparatus in which coils constituting a stator are cooled using cooling fluid supplied from a first channel pipe and a second channel pipe, and, particularly, the ends of the coils, which are difficult to sufficiently cool when cooling the motor, are efficiently cooled, thereby ensuring the durability of the motor.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

1. A motor-cooling apparatus comprising:
a motor housing including a rotor and a stator around which coils are wound;
a first channel pipe disposed outside the stator, the first channel pipe being configured to spray cooling fluid to an outside of the coils; and
a second channel pipe disposed inside the stator, the second channel pipe configured to spray the cooling fluid to an inside of the coils.

2. The motor-cooling apparatus according to claim 1, wherein first ends and second ends of the coils in the stator are exposed from two ends of the motor housing.

3. The motor-cooling apparatus according to claim 2, wherein the first channel pipe includes a plurality of first channel pipes disposed along an outer periphery of the stator, and extend in a longitudinal direction of the motor housing to spray the cooling fluid to one or both of the first ends and the second ends of the coils.

4. The motor-cooling apparatus according to claim 3, wherein the stator includes a bracket on an outer circumferential surface, and the first channel pipe is disposed on the outer circumferential surface of the stator beside the bracket.

5. The motor-cooling apparatus according to claim 3, wherein the first channel pipe is disposed at an upper side of the stator such that the cooling fluid sprayed from the first channel pipe flows downwards along the coils while cooling the coils.

6. The motor-cooling apparatus according to claim 3, wherein the first channel pipe includes a pair of first channel pipes disposed at an upper side of the stator, and wherein the pair of first channel pipes are spaced apart from each other in a circumferential direction of the stator.

7. The motor-cooling apparatus according to claim 2, wherein the second channel pipe is disposed inside the coils to correspond to one or both of the first ends and the second ends of the coils, and the second channel pipe extends in a circumferential direction of the stator to spray the cooling fluid to the inside of the coils.

8. The motor-cooling apparatus according to claim 7, wherein the second channel pipe is configured to spray the cooling fluid to the inside of the coils in two lateral directions.

9. The motor-cooling apparatus according to claim 1, wherein the first channel pipe and the second channel pipe are configured such that a path of the cooling fluid sprayed from the first channel pipe and a path of the cooling fluid sprayed from the second channel pipe do not overlap each other outside and inside the coils.

10. The motor-cooling apparatus according to claim 1, wherein the first channel pipe sprays the cooling fluid under a spraying pressure sufficient to move the cooling fluid to the inside of the coils from the outside of the coils.

11. The motor-cooling apparatus according to claim 1, wherein the motor housing includes an oil channel in which the cooling fluid is circulated, and the first channel pipe and the second channel pipe are connected to the oil channel to share the cooling fluid.

12. The motor-cooling apparatus according to claim 1, wherein the stator includes a plurality of slots formed in an inner circumferential surface of the stator and arranged in a circumferential direction, and the coils are hairpin coils fitted into the plurality of slots.
